(19) United States
(12) Patent Application Publication
(10) Pub. No.: US 2017/0129759 A1
(43) Pub. Date: May 11, 2017

(54) CONTAINER FILLING MACHINE WITH WEIGHING DEVICE AND WEIGHING METHOD

(71) Applicant: Sidel S.p.A. CON SOCIO UNICO, Parma (IT)

(72) Inventors: Enrico COCCHI, Parma (IT); Riccardo GUERRA, Parma (IT)

(21) Appl. No.: 15/302,486

(22) PCT Filed: Apr. 8, 2015
(86) PCT No.: PCT/IB2015/052562

§ 371 Date: Oct. 6, 2016

(30) Foreign Application Priority Data
Apr. 8, 2014 (EP) 14163950.0

(51) Int. Cl. B67C 3/20; G01G 17/06; B67C 3/22; G01G 3/15; B67C 3/24; B67C 3/00

(52) U.S. Cl. CPC B67C 3/202; B67C 3/242; B67C 3/007; B67C 3/225; G01G 3/15; G01G 17/06; B67C 2003/228

(57) ABSTRACT

The present disclosure is directed to a machine for filling at least one container with a pourable product. The machine includes a conveyor; at least one filling unit configured to engage the at least one container; and a weighing device coupled to the at least one filling unit and configured to provide weighing information related to a weight of the at least one container during a filling operation. The weighing device includes a support unit having a supporting arm configured to hold the at least one container and configured to be elastically deformed as a function of the weight of the at least one container being filled; and a sensing unit configured to provide a contactless sensing, wherein the sensing unit is configured to detect a distance from the supporting arm to a portion of the machine facing the supporting arm, the weight of the container being a function of the distance.

### TECHNICAL FIELD

The present invention relates to a filling machine, designed for filling containers with a fluid product, for example a pourable food product. In particular, the present invention relates to a filling machine provided with an improved weighing device, designed for measuring weight of a container being filled, and to a related weighing method.

### BACKGROUND ART

In the field of bottling of fluids, like pourable food products, in containers, like plastic or glass bottles or aluminum cans, a system is known comprising a feed line for feeding a succession of empty containers to a filling machine, in turn comprising a rotating conveyor (so called “carousel”), carrying a number of filling units. The filling units are mounted to rotate continuously about a longitudinal axis, engage the empty containers, fill the containers with the desired product, and then feed the containers to a capping machine, which is coupled to the filling machine by at least one transfer wheel and which closes the containers with respective caps.

Control of the level of fluid in the containers being filled is an important feature of the filling machine, to assure that the containers are filled at a desired and repeatable level.

Level control is achieved during filling operations by means of suitable measuring arrangements, which may include flowmeters, designed to measure the flow of the fluid fed in the containers from the filling units; visual inspection devices, designed to provide a visual monitoring of the fluid level in the containers; and/or weighing devices, designed to sense the progressively increasing weight of the containers, while filling operations are performed.

In particular, a known weighing device includes a load cell, which is designed to be coupled to the container and to the rotating carousel of the filling machine.

The load cell generally includes a flexible supporting arm, cantilevered from the rotating carousel and carrying the container at a free end thereof. The supporting arm is generally provided with off-center capability, in order to automatically compensate for different values of torque, due to different placement of the container, or a different inclination thereof (e.g. due to centrifugal effects during rotation of the rotating carousel of the filling machine).

The supporting arm of the load cell is integrally provided with sensors or transducers, generally including strain gages or similar sensing elements, which are designed to undergo a stress when the supporting arm is elastically deformed by the increasing weight of the container; the measured stress may be used as an indication of the weight value, by a suitably provided control electronics (which may also control filling operations, and in particular may be designed to stop filling, when a desired weight value is reached).

Known filling machines, including load cells, are for example disclosed in documents EP 1 025 424 B2, or EP 1 534 621 B1.

The Applicant has realized that known weighing devices in filling machines pose some concerns in the design of the same filling machines.

In particular, it is known that in the beverage field, an important issue relating to filling machines, at least in particular applications, is that of ensuring proper hygienic conditions during filling operations. In this respect, it is known that safety rules have to be complied with, as well as guidelines for proper operations are to be followed (e.g. those issued by the European Hygienic Engineering and Design Group—EHEDG), for example when filling is performed with an aseptic pourable food product, e.g. with a delicate product which cannot be added with a substantial amount of preservative substances.

In particular, inside an aseptic environment, such as the one that may have to be ensured for filling operations, some requirements have to be met, such as: the protection of electrical connectors has to meet the IP69K safety standards; the level of electrical noise has to be kept under a low threshold; maintenance time has to be short.

The Applicant has realized that weighing devices of a known type may not prove fully satisfactory as far as these requirements are concerned.

For example, standard weighing devices have strain gages, or similar sensing elements, attached (e.g. glued) on the mechanical support element, and electrical wires to be connected thereto. Design of the electrical connections may thus prove to be a difficult task in current systems, if hygienic requirements are to be satisfied.

Moreover, electrical elements and connections may even break due to the mechanical stresses generated in the weighing device; also, analog signals generated by strain gages or similar elements are generally of a very low value and thus subject to environmental electrical noise and thermal noise.

A proper implementation of the off-center capability of the load cell, and its coupling to the rotating carousel, may entail complex and expensive mechanical arrangements, e.g. using articulated parallelograms or similar structures, which may be difficult to achieve, while at a same time satisfying the desired electrical requirements.

### DISCLOSURE OF INVENTION

The aim of the present solution is consequently to solve, at least in part, the problems previously highlighted, and in general to provide an improved solution for a filling machine, particularly with respect to weighing of containers being filled.

According to the present solution, a filling machine and a related weighing method are thus provided, as defined in the appended claims.

### BRIEF DESCRIPTION OF THE DRAWINGS

For a better understanding of the present invention, preferred embodiments thereof are now described, purely by way of a non-limiting example, with reference to the attached drawings, wherein:

FIG. 1 is a schematic overall view of a filling machine, wherein the present solution may be applied;

FIG. 2 is a schematic representation of a weighing device for a filling unit of the filling machine, according to a possible embodiment of the present solution;

FIG. 3 is a schematic electronic block diagram of an electronic part of the weighing device of FIG. 2;

FIG. 4 is a circuit depiction of a sensing element in the weighing device of FIG. 2; and

FIGS. 5 and 6 are schematic representations of a sensing part of the weighing device, according to respective, different, embodiments of the present solution.

### BEST MODE FOR CARRYING OUT THE INVENTION

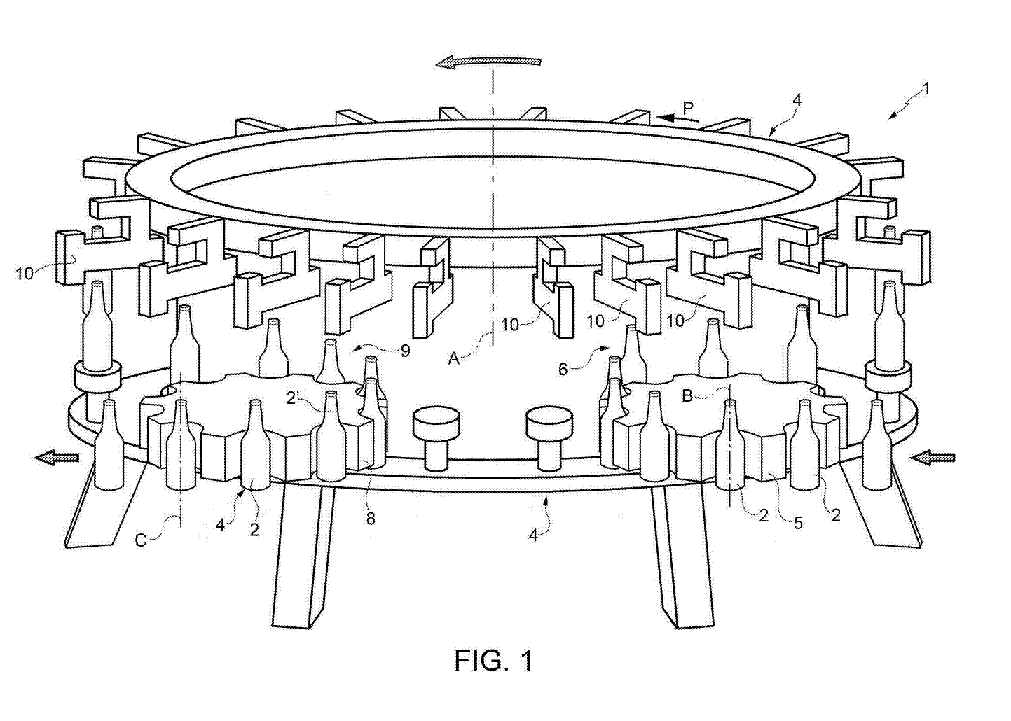

FIG. 1 schematically shows a machine, denoted as a whole with 1, for filling containers 2, for example glass or plastic bottles or aluminum cans, with a filling fluid, for example a pourable food product.

Filling machine 1 comprises a conveying device, including a rotating conveyor (or carousel) 4, which is mounted to rotate continuously (anticlockwise in FIG. 1) about a substantially vertical longitudinal axis A.

The rotating conveyor 4 receives a succession of empty containers 2 from an input wheel 5, which is coupled thereto 4 at a first transfer station 6 and is mounted to rotate continuously about a respective vertical longitudinal axis B, parallel to axis A.

The rotating conveyor 4 releases a succession of filled containers 2 to an output wheel 8, which is coupled thereto at a second transfer station 9 and is mounted to rotate continuously about a respective vertical longitudinal axis C, parallel to axes A and B.

Filling machine 1 comprises a number of filling units 10, which are equally spaced about axis A, are mounted along a peripheral edge of rotating conveyor 4, and are moved by the same rotating conveyor 4 along a path P extending about axis A and through transfer stations 6 and 9.

Each filling unit 10 is designed to receive at least one container 2 to be filled, and to perform, during its rotation along path P, a number of filling operations according to a filling “recipe”, in order to fill the container 2 with a fluid (e.g. a carbonated liquid).

In particular, the filling unit 10 is configured to engage the container 2, at an opening of a neck 2′ thereof, and includes one or more fluidic conduits and flow regulators (here not shown), which are designed to selectively couple the container 2 to one or more feed devices, or product tanks, of the filling machine 1 (here not shown).

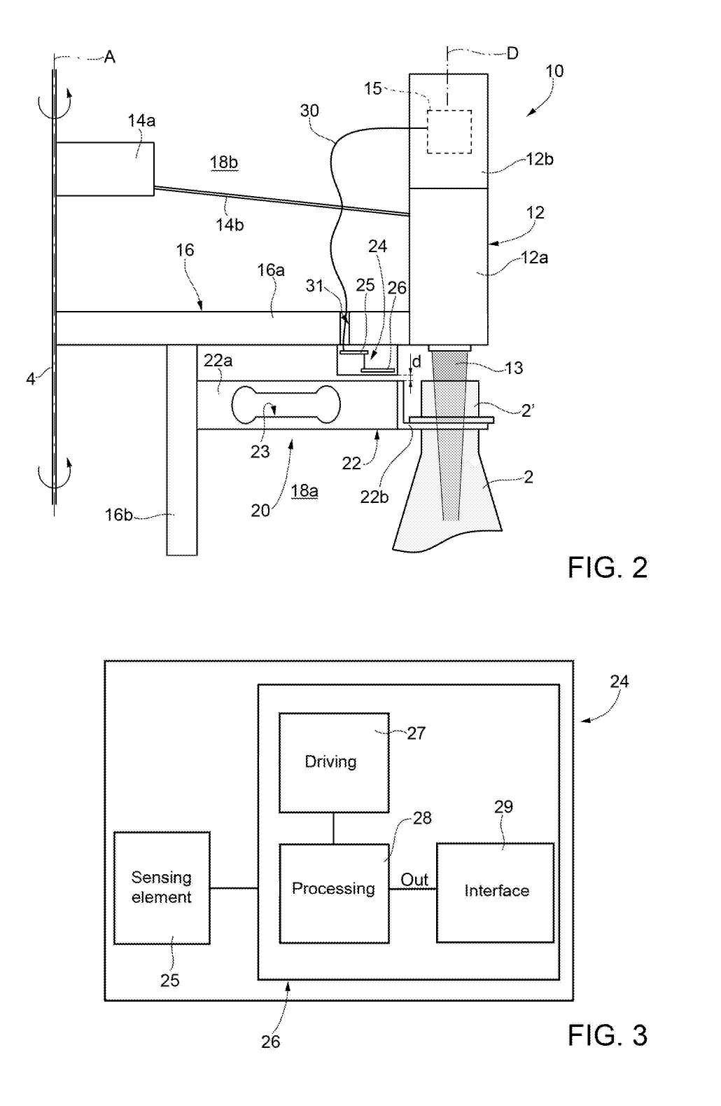

In more details, and as shown in FIG. 2 (which is not drawn to scale), each filling unit 10 includes a main body 12, having a vertical extension along a longitudinal axis D, that is substantially parallel to axis A of rotating conveyor 4.

The main body 12 has a bottom part 12a, which is mechanically coupled to the rotating conveyor 4, internally defines the filling conduits and flow regulators (here not shown) for a pourable filling product, here denoted with 13, and includes a container receiving part, designed to receive the neck 2′ of the container 2 that is to be filled. In the embodiment shown, bottom part 12a is coupled to a product feed line 14a, originated from a product tank 14b coupled to the rotating conveyor 4.

The main body 12 also has an upper part 12b, which houses an electronic control unit 15 (shown schematically), designed to control operation of the filling unit 10 (e.g. controlling the flow regulators, based on the desired filling plan); electronic control unit 15 is provided in a printed circuit board.

In a known manner, here not shown in detail, the portion of the rotating conveyor 4, to which the filling unit 10 is coupled, also defines, or is integrally provided with, a barrier structure 16, which divides and fluidically isolates and separates an aseptic area 18a of the filling machine 1, wherein aseptic conditions are preserved and where containers 2 are filled with the filling product 13, from a non-aseptic area 18b of the same filling machine 1.

In the exemplary embodiment schematically shown in FIG. 2, the barrier structure 16 includes an horizontal wall 16a, fixed to a plane or a horizontal table of rotating conveyor 4 (transversal to axis A) and coupled to the filling unit 10 at one end thereof; and a vertical wall 16b, joined to the horizontal wall 16a at a distance from the filling unit 10 and having a longitudinal extension parallel to axis A, at an opposite end of the horizontal wall 16a with respect to the same filling unit 10. Hydraulic separation means, here not shown, may generally be provided, to ensure proper separation of the aseptic area 18a from the non-aseptic area 18b.

According to an aspect of the present solution, the filling machine 1 includes a weighing device 20, configured to allow weighing of the container 2 being filled by the filling unit 10.

In a possible embodiment, filling machine 1 includes a number of weighing devices 20, each one operatively coupled to a respective filling unit 10.

Weighing device 20 includes a support unit 22, having a supporting arm 22a coupled to the rotating conveyor 4 at one end thereof, in particular to vertical wall 16b of the barrier structure 16. The supporting arm 22a is moreover coupled, at an opposite end, to a gripping element 22b, which is designed to grip the neck 2′ of the container 2, thus holding and supporting it during filling operations. Supporting arm 22a extends below the horizontal wall 16a of the barrier structure 16, thus within the aseptic area 18a, so that the supported container 2 is located below the respective filling unit 10.

Supporting arm 22a is flexible and elastically deformable, as a function of the increasing weight of the container 2 being filled.

In a possible embodiment, supporting arm 22a has off-center capability, so as to provide automatic torque compensation (in the schematic depiction of FIG. 2, supporting arm 22a is shown having a suitably shaped internal recess 23); in other words, deformation of supporting arm 22a is dependent only on the load, or weight of the container 2, and not on the resulting torque generated by the same load.

Supporting arm 22a is advantageously designed to be EHEDG compliant, i.e. designed according to hygienic requirements established by the European Hygienic Engineering & Design Group.

Weighing device 20 moreover includes a sensing unit 24, which is configured to provide weighing information related to the weight of the container 2 being filled.

According to an aspect of the present solution, sensing unit 24 is configured to provide a contactless position sensing, so as to provide a measure of a distance d of supporting arm 22a from a facing portion of the rotating conveyor 4 (in the example, from the horizontal wall 16a of barrier structure 16), whereby the weight of the container 2 is a function of this distance d.

As schematically shown also in FIG. 3, the sensing unit includes, for example encapsulated within a plastic housing: a sensing element 25, which is configured to sense the position of supporting arm 22a; and an electronic circuit 26, coupled to the sensing element 25.

Electronic circuit 26 includes: a driving circuitry 27, which is configured to drive the sensing element 25; a processing circuitry 28, which is configured to generate an output signal Out, preferably of a digital type, related to the sensed position; and an interface 29, which is configured to interface with an output system, in particular with the electronic control unit 15 of the filling unit 10, to provide thereto a measure of the sensed position (or distance d).

In a possible embodiment, interface 29 is of a digital type, for example including an SPI (Serial Parallel Interface) digital interface, capable of high speed operation.

According to an aspect of the present solution, the sensing element 25 operates based on the principle of electromagnetic inductive coupling.

Moreover, sensing element 25 is directly coupled to a surface of the rotating conveyor 4 (in particular, of the horizontal wall 16a of barrier structure 16), facing the supporting arm 22a, in the example in the proximity of the region of coupling of the same supporting arm 22a with the gripping element 22b.

Electrical wires and connectors, schematically shown as 30, connecting the sensing unit 24 to the external environment, in particular to the filling unit 10 (to provide output signal Out) and to a power supply system (here not shown), reach the same sensing unit 24 through a hole or passage 31 traversing the rotating conveyor 4 (in particular, formed through the horizontal wall 16a of barrier structure 16).

Advantageously, electrical wires and connectors 30 are thus not present in the aseptic area 18a of the filling machine 1, but extend only in the non-aseptic area 18b of the same filling machine 1.

In a possible embodiment, the sensing element 25 is configured to sense the effects due to the generation of circulating currents (so called eddy currents), as a consequence of a magnetic field.

In this case, supporting arm 22a includes a non-magnetic conductive material, for example a stainless steel or aluminum material.

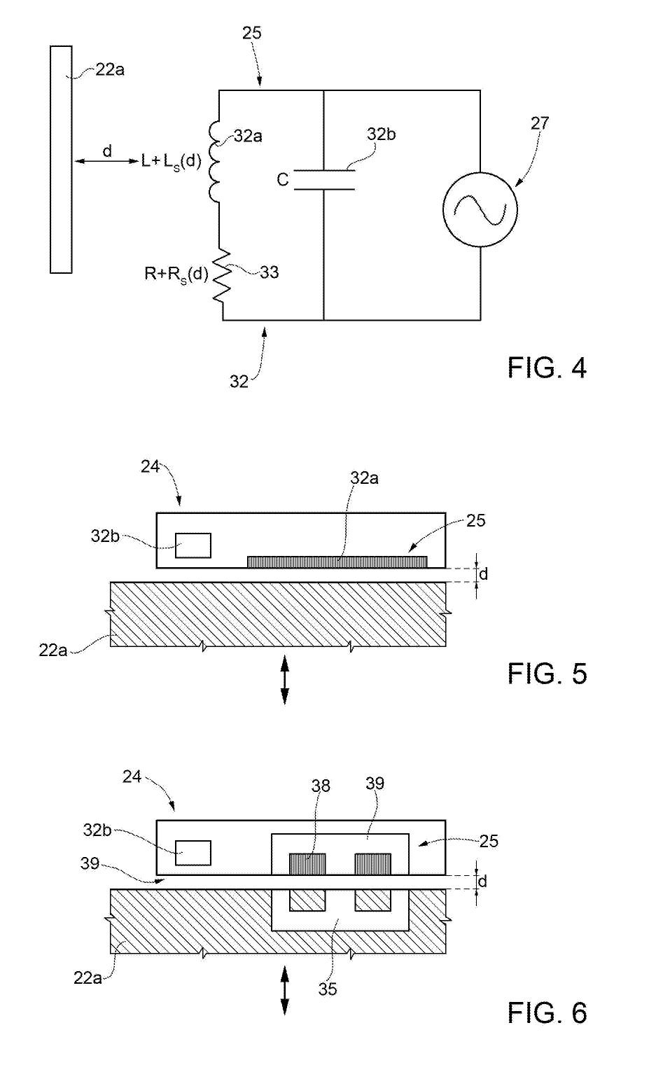

The sensing element 25, as also shown in the schematic diagrams of FIGS. 4 and 5, includes an LC resonator 32 (also defined LC resonant tank) formed by an inductor coil 32a, having inductance L, and a parallel capacitor 32b, having capacitance C, which may conveniently be integrated in a printed circuit board—PCB, together with the electronic circuit 26.

The LC resonator 32 is driven to oscillate at its natural resonance frequency by the driving circuitry 27 (here schematically represented as an oscillator circuit), in order to generate an AC current flowing in the inductor coil 32a. This current generates a magnetic field, which, in turn, induces eddy currents within the conductive material of the supporting arm 22a, which is arranged in the vicinity of the same LC resonator 32.

The magnitude of the eddy currents is a function of the distance d between the supporting arm 22a and the LC resonator (that is coupled to the rotating conveyor 4), which varies due to deformation of the same supporting arm 22a (as shown by the arrow in FIG. 5).

Eddy currents generate their own magnetic field, which influences and modifies the original magnetic field generated by the inductor coil 32a, introducing a parasitic inductance Lₛ, which varies the original inductance value L, as a function of distance d.

As shown schematically, also the value of a series resistor 33, having resistance R, is modified by the presence of the eddy currents, again with a parasitic component R, being a function of distance d.

Processing circuitry 28 in this case monitors the change of value of the inductance of inductor coil 32a and the resistance of resistor 33, by monitoring both of the following parameters: the resonance frequency of the LC resonator 32 (which is influenced by the change in the inductance value); and the power required to maintain an oscillation amplitude having a constant value (which is influenced by the change in the series resistance value).

Processing circuitry 28 thereby provides output signal

Out (which may be of a digital type), carrying information about distance d, to the interface 29, which in turns provides this information to the external electronic control unit 15 of filling unit 10.

In a manner not discussed in detail, the same electronic control unit 15 may process output signal Out, e.g. via linearization, filtering, amplification, and a proper conversion to a weight value.

In a possible alternative embodiment, sensing unit 24 is configured to provide an electromagnetic transformer, and to sense the variation in inductance due to inductive coupling with the supporting arm 22a.

In this case, and as schematically shown in FIG. 6, the supporting arm 22a includes a magnetic region 35, including a ferromagnetic material or a ferrite; sensing element 25, coupled to the rotating conveyor 4 (for example being fixed to the horizontal wall 16a of barrier structure 16) here includes a magnetic core 36, of a ferromagnetic material or a ferrite, and a winding coil 38, separated from the magnetic region 35 via an air gap 39, whose value is a function of distance d.

Winding coil 38 is driven by the driving circuitry 27, and processing circuitry 28 is here configured to monitor the change in the electrical characteristics of the same winding coil 38 (e.g. in terms of an overall coil inductance), as a function of distance d and the change in the air gap 39, thus generating output signal Out.

It is underlined that in any case no electrical parts or components are provided in, or coupled to, the supporting arm 22a in the aseptic area 18a of the filling machine 10, and electrical connection 30 to the sensing unit 24 is achieved entirely through the non-aseptic area 18b; in other words, the support unit 22 is purely of a mechanical type and does not include any electronic part or component.

The advantages that the described solution allows to achieve are clear from the foregoing description.

In particular, it is again underlined that the electronic components and electrical connections may be integrated and entirely arranged within the non aseptic region 18b of the filling machine 1, coupled to the rotating conveyor 4 thereof.

The support unit 20, carrying the container 2 being filled, may thus be a simple mechanical part, without any sensing element (such as strain gages), electronic parts or electrical wires.

Therefore, design of the support unit 20 is simpler and compliance to hygienic requirements more convenient; for example, support unit 22, and recess 23 of related supporting arm 22a, may conveniently be designed with rounded edges and without plane surfaces, where bacteria or other pathologic elements could gather.

Replacement of the same support unit 22, for example in order to accommodate different type of containers 2 or to correct faults, becomes very simple, since no electrical connections are to be interrupted and/or replaced; maintenance time may thus be reduced.

Moreover, sensing unit 24 is not subject to mechanical stress generated in the supporting arm 22a and thus is not subject to breaking or damages during filling operations.

Sensing becomes also less affected by noise and external electrical disturbances; indeed, inductive sensing and use of a digital interface guarantee signal integrity and intrinsic noise reduction, both with respect to thermal and environmental noise; a higher resolution may thus be achieved in weight measurement and consequently more efficient and reliable filling operations may be performed.

Finally, it is clear that modifications and variations may be applied to the solution described and shown, without departing from the scope of the appended claims.

For example, it is underlined that other types of contactless position sensors could be used in the sensing unit 24, e.g. using a laser interferometer or laser triangulation.

Moreover, the support unit 20 and related supporting arm 22a could have a different structure and conformation, in any case being deformable as a function of the container weight.

Also, it is clear that the discussed solution may advantageously be used also for different kind of containers, e.g. PET containers, to be filled and/or different kind of filling fluids, e.g. different from food products.

1. A machine for filling at least one container with a pourable product, the machine comprising:
a conveyor;
at least one filling unit conveyed by the conveyor and configured to engage the at least one container to be filled with the pourable product; and
a weighing device coupled to the at least one filling unit and configured to provide weighing information related to a weight of the at least one container during a filling operation, the weighing device including:
a support unit, having a supporting arm configured to hold the at least one container and configured to be elastically deformed as a function of the weight of the at least one container being filled; and
a sensing unit configured to provide a contactless sensing, wherein the sensing unit is configured to detect a distance from the supporting arm to a portion of the machine facing the supporting arm, the weight of the container being a function of the distance.

2. The machine according to claim 1, wherein the sensing unit is configured to operate based on electromagnetic inductive coupling, and includes a sensing element, facing the supporting arm.

3. The machine according to claim 2, wherein the sensing element includes an inductor coil for generation of a magnetic field, and the sensing unit is configured to sense electromagnetic effects due to eddy currents generated in the supporting arm. the supporting arm including a conductive material.

4. The machine according to claim 3, wherein the sensing element further includes a parallel capacitor coupled to the inductor coil to form an LC resonator, wherein the sensing unit includes a driving circuitry, configured to drive the LC resonator at its natural resonance frequency, thus generating the magnetic field.

5. The machine according to claim 2, wherein the sensing unit is configured to provide an electromagnetic transformer, and configured to sense the variation in an inductance, as a function of the elastic deformation of the supporting arm, the supporting arm including a region of a ferromagnetic material or a ferrite.

6. The machine according to claim 5, wherein the sensing element includes a magnetic core with a winding coil, separated from the magnetic region via an air gap, whose value is a function of the distance.

7. The machine according to claim 2, wherein a portion of the conveyor, to which the at least one filling unit is coupled, defines a barrier structure, which separates a first area of the machine from a second, distinct, area of the machine, the sensing element being coupled to the barrier structure; and
wherein electrical connection to the sensing unit is provided through a passage traversing the barrier structure, thereby extending solely in the second area and not in the first area.

8. The machine according to claim 7, wherein the first area is an area where aseptic conditions are to be preserved and where the at least one container is to be filled with the pourable product, and wherein the second area is a non-aseptic area.

9. The machine according to claim 1 any of the preceding claim, wherein the support unit is of a purely mechanical type and does not include any electronic parts or components.

10. The machine according to claim 1, wherein the at least one filling unit includes a control unit configured to control operations of filling of the at least one container, and wherein the sensing unit includes an interface configured to interface with the control unit of the at least one filling unit and to provide the control unit with the weighing information related to the weight of the at least one container.

11. The machine according to claim 10, wherein the interface is of a digital type, including an SPI (Serial Parallel Interface) digital interface.

12. The machine according to claim 10, wherein the weighing information includes a measure of distance, and the control unit is configured to determine the weight of the container as a function of the distance.

13. The machine according to claim 1, wherein the supporting arm has off-center capability, so as to provide automatic torque compensation, and is coupled to the conveyor at one end, and carries, at an opposite end, a gripping element, which is configured to grip a neck of the at least one container to hold and support the at least one container during the filling operation.

14. The machine according to claim 1, further comprising a plurality of filling units conveyed by the conveyor, and a plurality of corresponding weighing devices.

15. The machine according to claim 14, wherein the conveyor is mounted to rotate about a longitudinal axis, and conveys the plurality of filling units at a periphery of the conveyor, the plurality of filling units being configured to be moved along a path by a rotation of the conveyor.

16. A method of weighing at least one container during a filling operation in which at least one filling unit fills the at least one container with a pourable product, the method comprising:
providing weighing information related to a weight of the at least one container during the filling operation via a weighing device coupled to the at least one filling unit, the weighing device including: a support unit, having a supporting arm configured to hold the at least one container and configured to be elastically deformed as a function of the weight of the at least one container being filled,
wherein providing weighing information includes implementing a contactless sensing, including detecting a distance from the supporting arm to a portion of the machine facing the supporting arm, and determining the weight of the container as a function of the distance.

17. The method according to claim 16, wherein implementing a contactless position sensing operates based on electromagnetic inductive coupling.

18. The method according to claim 16, wherein implementing a contactless position sensing includes sensing electromagnetic effects due to eddy currents generated in the supporting arm, the supporting arm including a conductive material.

19. The method according to claim 16, wherein implementing a contactless position sensing includes providing an electromagnetic transformer, and sensing the variation in an inductance, as a function of the elastic deformation of the supporting arm, the supporting arm including a magnetic region of a ferromagnetic material or a ferrite.
